(19) United States
(12) Patent Application Publication
(10) Pub. No.: US 2023/0199920 A1
(43) Pub. Date: Jun. 22, 2023

(54) METHOD FOR OPERATING A COOKTOP AND COOKTOP

(71) Applicant: E.G.O. Elektro-Geraetebau GmbH, Oberderdingen (DE)

(72) Inventors: Kay David Baeumges, Wiernsheim (DE); Stephane Lomp, Gambsheim (FR); Etienne Fuchs, St. Leon-Rot (DE)

(21) Appl. No.: 18/066,379

(22) Filed: Dec. 15, 2022

(30) Foreign Application Priority Data
Dec. 21, 2021 (DE) 10 2021 214 821.2

(51) Int. Cl. H05B 6/06; H05B 6/12

(52) U.S. Cl. CPC H05B 6/065; H05B 6/1272; H05B 2213/05

(57) ABSTRACT

In a method for operating a cooktop having a cooktop plate and adjacent heating means arranged thereunder along a straight line, and a pan detection means for detecting a relative coverage of each heating means by cooking vessels placed thereover, it is detected in a preceding step over which of the heating means a cooking vessel has been placed and thus that a relative coverage is present. In a subsequent step, the pan detection means is used to detect how great is the relative coverage of each covered heating means, and from this result and a comparison of these results for each heating means a case analysis is performed into one of several cases. For a 1st case, in which it is detected for the three heating means arranged along the straight line, that the relative coverage of the middle heating means is less than the relative coverage of the other two adjacent heating means, it is determined that no cooking vessel has been placed over the three heating means which contiguously covers all three heating means, but rather that at least two cooking vessels have been placed over the three heating means.

### CROSS-REFERENCE TO RELATED APPLICATIONS

This application claims priority to German Application No. 10 2021 214 821.2, filed Dec. 21, 2022, the contents of which are hereby incorporated herein in its entirety by reference.

### FIELD OF THE INVENTION AND PRIOR ART

The invention relates to a method for operating a cooktop and to a cooktop designed to carry out this method.

Cooktops with “pan detection function” are known from the prior art and are also commercially available, see for example DE 10 2006 054 973 A1. A plurality of heating means in the form of induction heating coils are here in each case arranged in a straight line or row, for example six to eight in the first line and four in the second line. A pan detection means is in each case provided, in particular formed by the induction heating coils themselves, which can detect whether a cooking vessel has been placed thereover. The appropriate number of induction heating coils may then optionally be jointly operated for heating this cooking vessel.

### SUMMARY OF THE INVENTION

The object of the present invention is to provide an above-stated method and an above-stated cooktop with which prior art problems can be solved and it is in particular possible to detect very simply and practically what the cooktop coverage situation is and in particular to operate heating means at least partly automatically to heat a cooking vessel.

This object is achieved by a method having the features of claim 1 and by a cooktop having the features of claim 19. Advantageous and preferred configurations of the invention are the subject of the additional claims and are explained in more detail below. Some of the features are described only for the method or only for the cooktop. They are however intended to apply by themselves and independently of one another both to such a method and to such a cooktop. The wording of the claims forms part of the content of the description by explicit reference.

The cooktop has a cooktop plate and at least three heating means which are arranged adjacently along a straight line. Advantageously, these heating means adjoin one another directly without further heating means therebetween. The spacing between them may amount to at most 20 mm, advantageously at most 10 mm. The arrangement along a straight line is preferably to be understood as meaning that the central regions thereof about a centroid lie on a straight line, wherein these central regions cover around 10% to 20% of the total area of the heating means. Further explanations in this respect are provided below. Furthermore, the cooktop comprises a pan detection means, which is configured to detect the relative coverage of each of the heating

means by a cooking vessel placed over the heating means on the cooktop plate. In one simple configuration of the invention, the heating means takes the form of induction heating coils and may then even be part of said pan detection means, preferably forming the sole sensors for the pan detection means. In one alternative configuration of the invention, separate pan detection sensors are provided which fulfill this task.

According to the invention, in the method a preceding step uses the pan detection means to detect over which of the heating means a cooking vessel, if any, is placed and thus what, if any, is the relative coverage of this heating means. This step is advantageously only carried out for heating means which are arranged along a straight line. In this case, the above definition of the arrangement of heating means along a straight line may be assumed.

In a subsequent step, the pan detection means may also be used to detect or find out or measure how great the relative coverage by a cooking vessel is of each heating means over which such a cooking vessel, if any, has been detected. For both this step and the preceding step, it is the case that in principle it does not really matter whether such coverage is the result of a single cooking vessel or a plurality of cooking vessels. All that matters is how large the relative coverage of a heating means is by at least one cooking vessel placed thereover or by a plurality of cooking vessels placed thereover, i.e. what percentage of the heating means is covered.

Once it has been detected or measured for each of the at least three stated heating means whether and how large their relative coverage is, these results are compared with one another. In particular, coverage and the relative magnitude of the coverage, if any, is detected for all the heating means of the cooktop, such that these are detected for the entire cooktop. Then, a case analysis is performed and the presence of one of several cases is detected or determined. These cases all relate to the coverage of heating means with at least one or with precisely one cooking vessel, possibly indeed with two cooking vessels.

The presence of a 1st case is identified if it is detected for the at least three heating means arranged along the straight line that the relative coverage of the middle heating means, lying therefore between the other two heating means, is less than the relative coverage of the other two adjacent heating means. In this 1st case, it is determined that no cooking vessel is placed over the three heating means which contiguously covers all three heating means, or indeed even more heating means. Thus at least two cooking vessels must be placed over the three heating means, with the obvious prerequisite that a cooking vessel or part of a cooking vessel has been detected over all three heating means, i.e. all three are at least partly covered. In this 1st case, it may for example be that two cooking vessels are placed over the three heating means and the

two cooking vessels jointly cover the middle heating means, but to a lesser extent, the proportion of this latter which is covered being less than the proportion of the other two outer heating means. It may in this case namely be assumed that if all three heating means are covered by a single cooking vessel the middle heating means should be at least as extensively covered as the adjacent two, or indeed even more extensively, relatively speaking. If this is not the case, because the middle heating means has lower relative coverage, it cannot be the case that one individual cooking vessel covering all three heating means is provided. It may advantageously be assumed for the method that although such a case is in some way per se possible, it is however regarded as so rare or impractical that it is considered a non-occurring case.

In one advantageous configuration of the invention, provision may be made for an operator to intervene in a case analysis result which, advantageously in the 1st case, means separate operation of the heating means. Through appropriate operation, said operator may determine that all three heating means are jointly operated with the same power stage, to heat any cooking vessels placed thereover.

In one advantageous configuration of the invention, provision is made for the pan detection means to have at least three pan detection sensors. Each heating means of the cooktop is advantageously associated with precisely one pan detection sensor. Particularly advantageously, this pan detection sensor is integrated into the heating means, advantageously such that the heating means is an induction heating coil, which is driven and evaluated in such a way that it in itself detects a cooking vessel placed thereover and also the relative coverage brought about thereby. These pan detection sensors may detect cooking vessels which are placed over the heating means and detect their placing location and the relative coverage of a respective heating means by a cooking vessel placed thereover. Particularly advantageously, the induction heating coils acting as pan detection sensors are the sole sensors for such pan detection. In such a case, it is possible to reduce structural complexity and the complexity of cooktop driving and evaluation.

In a further advantageous configuration of the invention, it is possible that, before said case analysis, i.e. in a preceding step, the relative coverage of all the heating means is detected using the pan detection means and the pan detection sensors. In this case, the intention is to detect which heating means are covered to any extent by a cooking vessel, irrespective of the number of cooking vessels. This is then only the result obtained after the case analysis has been carried out. It may moreover be detected to what extent each heating means is covered by one cooking vessel or plurality of cooking vessels placed thereover, i.e. the magnitude of the relative coverage thereof.

In a further configuration of the invention, the case analysis may produce a 2nd case, which is based on the 1st case. A decision in favor of this 2nd case is made if it is detected for the middle heating means, between the adjacent two heating means, that the relative coverage thereof is greater than zero, i.e. that at least one cooking vessel is placed thereover. The relative coverage of the other two adjacent heating means is the same, i.e. they are likewise covered by at least one cooking vessel. In this 2nd case, it is determined that the three heating means are covered by precisely two cooking vessels, wherein one of the two adjacent heating means is covered by precisely one first cooking vessel, i.e. not by any more. The other two heating means, i.e. the middle heating means and the other adjacent heating means, are jointly covered by another, second cooking vessel. The probability of a large casserole dish or the like covering all three adjacent heating means at the same time and with the same relative coverage is very slight or impossible. In general, large casserole dishes are after all oval in form, such that the narrower ends would lie at least in part over the adjacent outer heating means, such that these would then have lower relative coverage than the middle heating means.

In the above-stated 1st case, it may advantageously be assumed or determined, as described for the 2nd case, that a total of two cooking vessels have been placed over the three heating means. Here too, provision may advantageously be made for a total of two cooking vessels to be placed over the three heating means. It is then clear that not all three heating means are jointly operated with the same power stage. Since the cooktop also cannot decide solely on the basis of this information which two adjacent heating means are covered jointly by one cooking vessel, it follows that all the heating means are, as first approach, operated separately or independently of one another. An operator must then perform a manual adjustment to ensure two heating means are jointly operated, i.e. linked, so to speak, with the same power level, if that is what is wanted. Doing this is, however, no longer part of the present invention or is performed independently thereof, because it is not automatic. The actual operation of a heating means, in particular if these are induction heating coils, proceeds advantageously with specified power densities, i.e. power per unit area. When linking a plurality of heating means, i.e. in the case of joint operation, these are advantageously operated with the same power density, such that a cooking vessel placed thereover may be heated approximately uniformly over the entire area of the base without regions of a markedly higher or markedly lower temperature.

In a further configuration of the invention, a 3rd case is provided, in which it is detected for the three heating means arranged along the straight line that the relative coverage of the middle heating means is greater than the relative coverage of the other two adjacent heating means, and indeed greater than that of the one adjacent heating means and also greater than that of the other adjacent heating means. Provision may in particular be made for the relative coverages of the other two adjacent heating means to differ from one another. This difference is advantageously only at most 20%, however. In this 3rd case, it is then determined that a single cooking vessel is placed over the three heating means which contiguously covers all three heating means. In this case, the three heating means may advantageously be linked, as it were, and then operated jointly and automatically by a cooktop controller, such that an operator only has to input or specify a power stage once, this then applying to all three heating means. In this case, it is assumed or determined that the single cooking vessel is a very large pan or a “casserole dish”, which is elongate/oval in shape. The precise shape of this single cooking vessel is of no relevance, however, since further analysis is unnecessary.

In a further configuration of the invention, a 4th Case may be provided in which a relative coverage of less than 30% of the middle heating means is detected, in particular less than 20% or even less than 10%. For the other two adjacent heating means, a relative coverage of more than 30%, advantageously more than 50%, is in each case detected. It is then determined that no cooking vessel is placed over the middle heating means or a cooking vessel placed thereon covers this heating means only very slightly. Instead, one cooking vessel is placed over each of the other two adjacent heating means. From this, the cooktop controller may draw the conclusion or determine that none of the three heating means is operated in linked manner with one of the others, but rather the power is set separately in each case. One of the two adjacent, i.e. outer, heating means may possibly be operated in linked manner with a still further adjacent heating means. This has however to be assessed in turn according to other criteria.

In a further configuration of the invention, a 5th Case may be provided, in which it is determined for the three above-stated heating means and then also for a fourth, which likewise lies in a straight line with the other three heating means, that each thereof is covered by a cooking vessel or has a relative coverage which is advantageously greater than 5% or greater than 10%. Then the relative coverages of the middle two heating means are in each case compared with the relative coverages of the outer two heating means. In a 1st Sub-case, in which the relative coverages of the middle two heating means are in each case greater than the relative coverages of the outer two heating means, it is determined that a single, very large cooking vessel is placed over all four heating means and contiguously covers these four heating means. The four heating means may thus be operated in linked manner by a cooktop controller, i.e. automatically interconnected and operated with a common power or power stage. No separate operating procedure is necessary for this linking operation.

In the 1st sub-case, it is assumed that such a very large cooking vessel is either round or oval in shape, i.e. in any case it covers a smaller proportion of the outer two heating means than of the middle two heating means in the middle region.

In another, 2nd sub-case, it is determined that the relative coverages of the middle two heating means are in each case smaller than the relative coverages of the outer two heating means. In this case, it is determined that in each case one cooking vessel is placed over each of the outer two heating means and the directly adjacent middle heating means and jointly covers these two heating means. It is thus determined that the four heating means are covered by two cooking vessels, specifically in each case two directly adjacent heating means are covered by one common cooking vessel. In a still further configuration of the invention, it may be determined that the two cooking vessels have been placed only over these two heating means, i.e. no linked operation with further heating means is needed or intended.

In one possible further development of the invention, provision may be made for the relative coverages of the respective heating means to be set in relation to one another. This is advantageously done for the at least three heating means along the straight line, particularly advantageously for all the heating means which are arranged along a straight line in accordance with the above-stated criteria. In this case, a distinction is drawn between on the one hand heating means which are covered to a relatively large or extensive degree and on the other hand heating means covered to a relatively small degree. This may be carried out in such a way that the criterion consists in 50% or more of the relatively most extensively covered heating means being classified into the group of extensively covered heating means and the other 50% or less into the group of slightly covered heating means. How extensive or large the relative coverage is in itself is thus not examined but rather merely how large the relative coverage of one heating means is compared with the relative coverages of the other heating means. In one alternative configuration, provision may be made for heating means with a relative coverage of more than 50% to be classified in a group of extensively covered heating means. Heating means with a relative coverage of less than 50% are classified in the other group, i.e. with less than 50% coverage. The heating means can be grouped in this way.

In one advantageous configuration of the invention, it is irrelevant how conditions change over time on the cooktop, or coverage is not looked at over time. Thus, for example, the cooktop status may be analyzed when cooking vessels are placed thereon, as soon as the cooktop has been switched on. In this respect, it may in particular be disregarded at what point in time cooking vessels were set in place or detected as having been set in place.

In one advantageous further configuration of the invention, provision may be made for the method to be carried out only if the pan detection means or the pan detection sensors identify no movement of a cooking vessel on the cooktop plate. Then the method may be interrupted, as it were. Only when conditions which are static or unchanging over time again prevail are the initially mentioned step and then the subsequent step begun again.

In a further development of the invention, there is a 6th case, in which, when a minimum relative coverage of a heating means is detected between two maximum relative coverages of heating means, it is determined that in each case precisely one cooking vessel is placed over a heating device with a maximum relative coverage. Whether the minimum is here identified over a single heating means or over two adjacent heating means is irrelevant. All that matters is whether a minimum relative coverage may be identified between two maximum relative coverages. These maximum values may also differ from one another, but the relative coverage must be greater than the minimum relative coverage. Each of the maximum values may also be identified over a single heating means or over two heating means. Likewise, each of the two maximum relative coverages can be identified over a single heating means or over two heating means. In this case of identifying the minimum between two maximum values, it is determined that the one heating means and the heating means with a minimum relative coverage are covered only by marginal zones of cooking vessels placed next thereto over the maximum values, such that an intermediate region between these two cooking vessels is determined over the at least one heating means with minimum relative coverage. It may follow from this that, depending on the extent of relative coverage, the at least one heating means with the minimum relative coverage does or does not contribute to heating. This may be made dependent on the extent of relative coverage. If this relative coverage of the at least one heating means lies below 20% and this is probably produced jointly by two cooking vessels, it may be assumed that these two cooking vessels are placed only to a very small extent over this or these relatively minimally covered heating means. Then they do not have to contribute to heating. If, on the other hand, the extent of relative coverage lies above 50%, heating may be advantageous or under certain circumstances even necessary. It is then recommended that heating may be carried out at least with a heating power of that adjacent heating means which has the lower of the relatively maximally covered heating means.

In a still further development of the invention, a 7th case may be provided in which a heating device with a maximum relative coverage is detected between two heating means with a minimum relative coverage. In this 7th case, it is assumed or determined that two cooking vessels have been placed over the at least three heating means. A cooking vessel is here placed over the interposed heating means with the maximum relative coverage and jointly over one of the adjacent heating means. The other cooking vessel is placed over the other adjacent heating means, but advantageously does not cover the interposed heating means at all. Particularly advantageously, it is additionally possible to determine that that cooking vessel which jointly covers the two heating means is larger than the other cooking vessel, which is placed over the single heating means.

In one preferred configuration of the invention, the heating means are not of round or circular configuration, but rather are square or rectangular. In this case, they have a length and a width with the length being greater than the width. The width should be less than 20 cm, in particular it should be less than 15 cm, but in particular greater than 8 cm. The length is advantageously greater than 15 cm, particularly advantageously even greater than 20 cm, but in particular less than 30 cm. It may thus be ensured that two heating means are arranged with their longitudinal sides next to one another and the area formed by these two heating means resembles a square or does not differ too much from a square shape. In this way, it can be ensured that a usually round cooking vessel can be very well heated. In the case of a cooktop according to the invention, at least three heating means may be arranged along the straight line under a cooktop plate, advantageously in a direction from front to back. Particularly advantageously, there are four heating means, the width of which is 10 cm to 12 cm. In the case of a narrow cooktop with a width from left to right of around 60 cm to 70 cm, two such rows of heating means may be provided along parallel straight lines from front to back. The length of the heating means may then be 20 cm to 24 cm, i.e. roughly double the above-stated width. The length of the heating means here extends in a direction parallel to the widthwise direction of the cooktop. In the case of a wide cooktop with an installation dimension of 75 cm to 90 cm, three such lines of heating means, advantageously in each case of four heating means, may be provided. In an alternative configuration of the invention, a cooktop may also be very wide and have a depth of just one or two heating means one behind the other. Then the straight line of heating means extends not from front to back, but rather from left to right.

In one further configuration of the invention, it may be specified that pan detection and case analysis only functions or is carried out if a total of at most two cooking vessels are placed along heating means in a straight line. Otherwise the analysis is too difficult.

Provision is preferably made that, in the event that no values are detected for relative coverage of heating means arranged in a straight line which differ by more than 10%, or in the event that the relative coverage of all the heating means amounts in each case to less than 50%, it is assumed that two cooking vessels have been placed over the heating means. These then have a moderate size which may advantageously correspond to a diameter of between 15 cm and 22 cm. If the relative coverage amounts to more than 50%, however, that is of all the heating means over which a cooking vessel is identified, then one very large cooking vessel is assumed to be over the heating means. The diameter thereof may lie between 22 cm and 35 cm. Here, the case analysis may be carried out for three or for four heating means along a straight line. Such a very large cooking vessel would then usually be a very large casserole dish, as mentioned above.

In addition to the above-stated cooktop controller, the cooktop also has the pan detection means. In the event that the heating means are induction heating coils, this is advantageously formed by the inverter needed for driving thereof. On the basis of the current and voltage profiles at the induction heating means, this inverter detects the relative coverage thereof. This pan detection means then transmits the information relating to relative coverage to the cooktop controller, which undertakes the case analysis. Furthermore, the cooktop controller may then carry out the interconnection or linking of adjacent heating means for joint heating and for joint power setting.

These and other features emerge from the description and the drawings, in addition to the claims, wherein the individual features can be realized in themselves either alone or severally in the form of sub-combinations in one embodiment of the invention and in other areas, and can constitute advantageous embodiments eligible for protection in themselves, for which protection is sought here. The subdivision of the application into individual sections and subheadings does not limit the general validity of the statements made thereunder.

### BRIEF DESCRIPTION OF THE DRAWINGS

Exemplary embodiments of the invention are explained in more detail in the below and are shown schematically in the drawings, in which:

FIG. 1 is a plan view onto a cooktop according to the invention with two rows each of four induction heating coils, wherein pans are placed thereon in different ways,

FIGS. 2 to 5 show further different configurations of pans, which are placed in different ways over the induction heating coils.

### DETAILED DESCRIPTION OF THE EXEMPLARY EMBODIMENTS

FIG. 1 shows a plan view onto a cooktop 11 according to the invention, the cooktop having a cooktop plate 12. In the front, middle region there is arranged an operating means 14 with operating elements 15 and a display which is not shown, advantageously an LED display. The operating means 14 is advantageously arranged under the cooktop plate 12 and the display thereof is visible and operable through the cooktop plate 12, as known from the prior art.

The cooktop 11 has a controller 17 connected with the operating means 14. This may implement operating commands and also drive a display. The controller 17 is in turn connected with an inverter 19 for the cooktop 11 and gives commands thereto. The inverter 19 in turn controls the induction heating coils I of the cooktop 11 in a known manner. These induction coils I are divided into a left-hand row or group and a right-hand row or group, specifically in each case four induction heating coils. On the left-hand side, the induction heating coils are numbered IL1, IL2, IL3 and IL4. On the right-hand side, the induction heating coils are numbered IR1, IR2, IR3 and IR4. In other configurations, there could be just three induction heating coils I or five or even more. These two groups of induction heating coils I are arranged along a straight line, which runs from front to back. They are here arranged precisely one behind the other, but could alternatively also be offset slightly to the left or to the right, for example by 1 cm to 3 cm or even 5 cm. The dimensions of the induction heating coils I are such that they have a length from left to right of about 22 cm and a width from front to back of about 10 cm. They could also be of trapezoidal configuration, in particular they could be arranged variably offset relative to one another.

Together with the inverter 19, the induction heating coils I form not only the heating device for the above-stated cooking vessels, in the form of pans T, placed onto the cooktop plate 12 but also at the same time the pan detection means. This pan detection function via the induction heating coils I themselves is known to a person skilled in the art from the prior art. In principle, additional separate pan detection sensors could also be provided in the form of small induction coils for example. However, these are not necessary. Furthermore, this pan detection means that is formed of the induction heating coils I and the inverter 19 and in which the induction heating coils I function as pan detection sensors, may be configured to detect the relative coverage of each induction heating coil I with a pan T or a corresponding article or cooking vessel. This is detectable from the power and voltage of the drive circuit of each induction heating coil I. This is also known to a person skilled in the art from the prior art.

Two pans TL1 and TL2 roughly identical in size are placed over the left-hand row of induction heating means IL1 to IL4. The front pan TL1 stands over the front two induction heating coils IL1 and IL2 and is offset somewhat towards the front. This may possibly be because it is more practical for an operator to set it down thus. The rear pan TL2 stands over the rear two induction heating coils IL3 and IL4 and is also drawn somewhat to the front and thus the front induction heating coil IL3 is covered to a greater extent than the rear induction heating coil IL4. This scenario corresponding to the above-mentioned 1st case means that the pan detection means on the one hand identifies that a pan has been placed over all the induction heating coils IL, and that to a considerable extent, which may here mean that the relative coverage is over 5% or even over 10%. Specifically, it is over 60%. On the other hand, the pan detection means may identify that induction heating coils IL1 and IL3 have a somewhat higher relative coverage than induction heating coils IL2 and IL4. It is thus identified for the induction heating coil IL2 that it has, in accordance with the 1st case, a relative coverage which is less than that of the two induction heating coils IL1 and IL3 arranged next to it. Although the difference may not be particularly great, it is noticeable and amounts in the present case to at least 10%. Thus, due to the smaller relative coverage of induction heating coil IL2 between induction heating coils IL1 and IL3, it is determined that no individual cooking vessel contiguously covering these three induction heating coils IL1 to

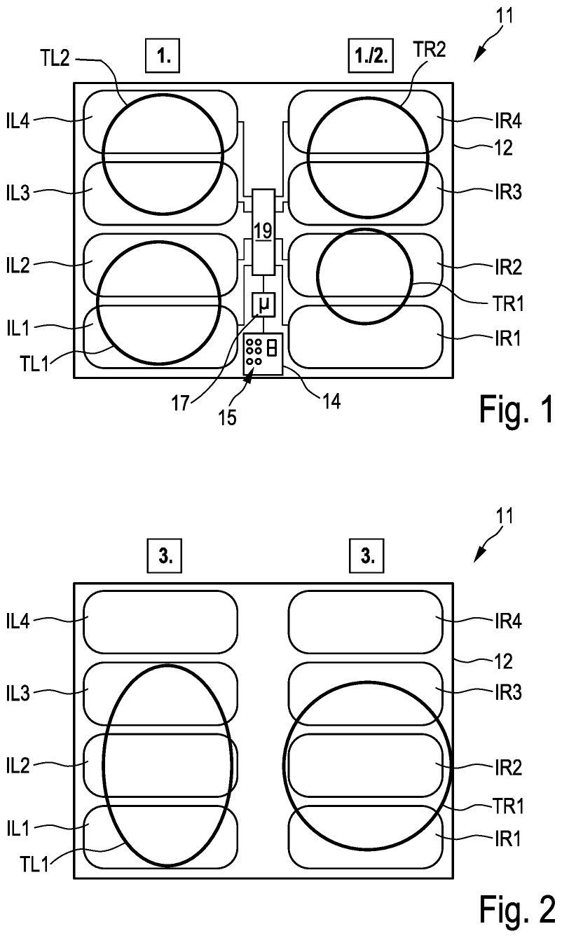

IL3 has been placed thereover. The 3rd case has therefore not arisen, this being shown on the left in FIG. 2 with the casserole dish TL1 shown therein. Instead, the pan detection means detects in this 1st case that at this moment at least two pans have been set in place. Since the pan detection means together with the controller 17 detects that the rearmost induction heating coil

IL4 also has a relative coverage of around 50%, it determines that the relative coverage of the induction heating coils IL3 and IL4 is not achieved in each case by a single cooking vessel, which would then be rather small, but rather altogether by one cooking vessel. Because of the relatively somewhat smaller relative coverage of induction heating coil IL2 compared with the two adjacent cooking vessels, there cannot be just one cooking vessel covering all four or all three front induction heating coils IL. It is indeed determined therefrom, in accordance with the 1st case, that one pan TL1 has been placed over the front two induction heating coils IL1 and IL2 and one pan TL2 over the rear two induction heating coils IL3 and IL4. However, more pans have also not been placed over the left-hand induction heating coils. Although the precise position of the respective pan, i.e. whether or that it covers the one induction heating coil IL somewhat more than the other, may be identified, it is of no relevance here or is not used.

From this determination, the controller 17 may link the two induction heating coils IL1 and IL2 together, and likewise the two induction heating coils IL3 and IL4. This means that operation with one of the operating elements 15 simultaneously and identically brings about one power stage for the two linked-together induction heating coils. This enables simpler, more convenient operation.

The right-hand side of FIG. 1 shows that a smaller-size pan TR1, for example with a diameter of about 15 cm, is mainly placed over the induction heating coil IR2 and covers the front induction heating coil IR1 only very slightly, for example with relative coverage of only about 10%. The induction heating coil IR2 is covered in a proportion of about 60%.

A large pan TR2, with a diameter of about 18 cm, stands over the two rear induction heating coils IR3 and IR4, said pan being displaced somewhat towards the rear or covering the rear induction heating coil IR4 with greater relative coverage than the induction heating coil IR3. Thus, the relative coverage of induction heating coil IR3 is less than that of the two adjacent induction heating coils IR2 and IR4. It is thus on the one hand determined, in accordance with the 1st case, that these three induction heating coils cannot be jointly covered by a single large cooking vessel. This is indeed true. Moreover, the 2nd case is detected, specifically because the middle induction heating coil IR3 has a relative coverage greater than zero and the relative coverages of the two adjacent induction heating coils IR2 and IR4 are roughly equal. It is accordingly determined, a situation which also applies to the left-hand row of induction heating coils IL, that in accordance with this 2nd case the induction heating coil IR2 is covered by a single cooking vessel, namely the pan TR1. This may also be substantiated by the fact that it is detected for the frontmost induction heating coil IR1 that the relative coverage is very slight, and it may accordingly be stated that this relative coverage must be caused by pan TR1, which has been placed over induction heating coil IR2. The rear two induction heating coils IR3 and IR4, on the other hand, are jointly covered by a single large cooking vessel, namely pan TR2, which has been displaced somewhat towards the rear, and may be operated in linked manner.

The left-hand side of FIG. 2 shows a scenario in which a large casserole dish TL1 of a length of around 30 cm is placed over the front three induction heating coils IL1 to IL3, said casserole dish completely covering these in the direction from front to back. The large casserole dish TL1 means that the relative coverage of the middle induction heating coil IL2 is greater than that of the adjacent two induction heating coils IL1 (in front) and IL3 (behind). The relative coverage of these is in turn relatively similar, such that the above-mentioned 3rd case is detected or determined. Here too, the three induction heating coils IL1 to IL3 are linked by the controller 17 for simpler operation.

The right-hand side of FIG. 2 shows that the three front induction heating coils IR1 to IR3 are also covered by a common single cooking vessel TR1, here shown as round pan TR1. The relative coverage of the middle induction heating coil IR2 is the greatest by far, being 100%. The relative coverage of the other two induction heating coils IR1 and IR3 is in turn identical and around 60%. It is thus determined therefrom that the 3rd case is fulfilled. Similarly as described for the left-hand row of induction heating coils ILL the three induction heating coils IR1 to IR3 are here also linked together by the controller 17 or interconnected for joint setting of a power stage.

With the left-hand row of induction heating coils IL shown in FIG. 3, a small pan TL1 is placed over the second induction heating coil IL2 and covers the third induction heating coil IL3 very slightly, for example to an extent of only 5%. The frontmost induction heating coil IL1 is not covered at all thereby. A small pan TL2 of similar diameter is placed over the rearmost induction heating coil IL4, and covers only about 3% of the induction heating coil IL3 in front thereof. The two pans TL1 and TL2 have a diameter of around 13 cm.

The very small relative coverage of the induction heating coil IL3 and the lack of coverage of the frontmost induction heating coil IL1 means that the pan detection means and the controller determine that the pans TL1 and TL2 are placed only over induction heating coils IL2 and IL4. The 4th case is thus fulfilled. The pan detection means cannot detect whether the small relative coverage of the induction heating coil IL3 is brought about by one pan or by two pans, and if so, from which of the adjacent induction heating coils. Since the relative coverage is so small, however, this is irrelevant. None of the induction heating coils, in particular neither of induction heating coils IL2 and IL4, are linked together or operated jointly. Their power setting thus proceeds separately. Furthermore, absolutely no power is drawn for induction heating coil IL3 and it is not operated.

Furthermore, on the left-hand side of the cooktop 11 of FIG. 3, the 6th case is also fulfilled, since a minimum relative coverage is determined over induction heating coil IL3. A maximum relative coverage is detected for the two adjoining induction heating coils IL2 and IL4. With regard also to this 6th case, the controller 17 determines that in each case precisely one pan TL1 or TL2 is placed respectively over just the two induction heating coils IL2 and IL4.

On the right-hand side in FIG. 3, a somewhat larger pan TR1, the diameter of which may be around 16 cm, is placed over the induction heating coils IR2 and IR3. It stands mainly over induction heating coil IR2 and the relative coverage thereof is around 65% and is greater than the relative coverage of induction heating coil IR3, which is covered in a proportion of around 25%. A small pan TR2 with a diameter of around 13 cm is placed over the rear induction heating coil IR4 and overlaps or covers the induction heating coil IR3 only very slightly. A relative coverage of around 45% is detected for the induction heating coil IR4. According to the above-described and here also identified 6th case, it is determined that a minimum relative coverage is present over induction heating coil IR3, thus between the two maximum relative coverages of induction heating coils IR2 and IR4. It is thus also determined that in each case one pan TR1 or TR2 is predominantly placed respectively over the induction heating coils IR2 or IR4. Whether the interposed induction heating coil IR3 is operated for heating is to be decided on the basis of the relative coverage thereof. Since this, unlike in the 4th case, is over 20%, it is determined, in a general extension of the 6th case, that it will likewise be operated. It cannot however be detected whether it is covered by a common cooking vessel jointly with the front induction heating coil IR2 or with the rear induction heating coil IR4, which in each case are adjacent. It cannot therefore be arbitrarily linked with one of the two induction heating coils IR2 or IR4. The controller 17 may here decide that it is operated with the power which is the lower power of the two induction heating coils IR2 and IR4. It is thus not in any event operated too strongly or with too much power.

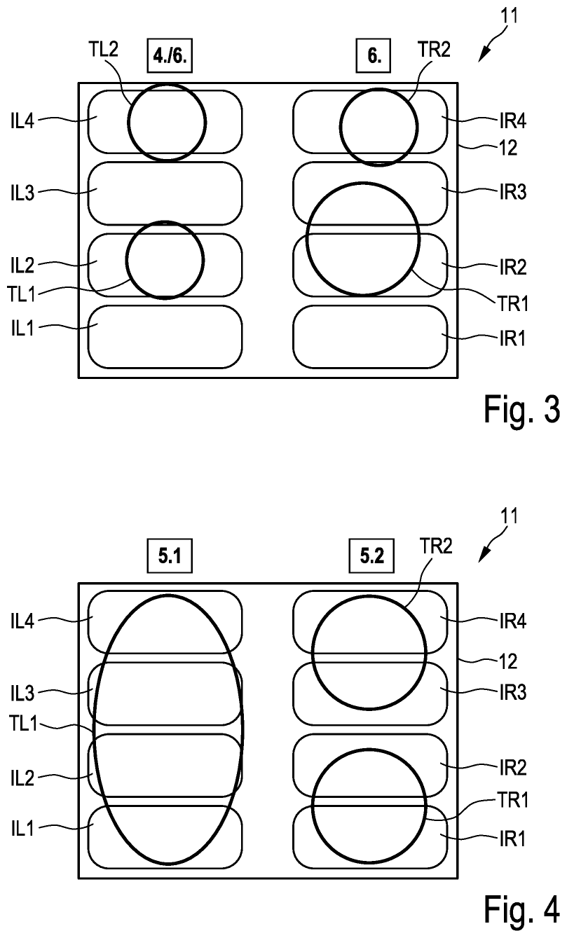

On the left-hand side in FIG. 4, it is shown how a very large casserole dish TL1 covers all four left-hand induction heating coils IL1 to IL4 of induction cooktop 11. This casserole dish TL1 is even larger than that of FIG. 2. The pan detection means here detects for the two middle induction heating coils IL2 and IL3 a relative coverage of around 90%, while the induction heating coils IL1 and IL4 have a relative coverage of only roughly 50% to 60%. The above-stated 5th is therefore determined to be fulfilled, specifically with the 1st sub-case. It is accordingly determined that the four induction heating coils IL1 to IL4 are linked together and operated jointly at the same power level. To set this power level, an operator has thus merely to actuate a single operating element 15 of the operating means 14, which is very simple and convenient.

On the right-hand side in FIG. 4, it is shown how two equal-sized pans TR1 and TR2, which correspond to the pan TR2 on the right in FIG. 1, are placed over the induction heating coils IR1 to IR4. Here, the front pan TR1 has been drawn forward somewhat and the pan TR2 pushed somewhat to the back. The relative coverages of the induction heating coils IR1 and IR4 are roughly equal and greater than in each case the relative coverages of the induction heating coils IR2 and IR3 located therebetween. Therefore the 2nd sub-case 5.2 of the 5th case is determined, and the 1st sub-case 5.1 shown on the left, with the single, very large cooking vessel contiguously covering all four induction heating coils is not identified. Since, moreover, the relative coverages of the middle two induction heating coils IR2 and IR3 are smaller than those of the outer two induction heating coils IR1 and IR4, and thus the case is precisely the reverse of what is shown on the left according to the 1st sub-case 5.1, it is here determined that a total of two pans TR1 and TR2 have been set in place. The front two induction heating coils IR1 and IR2 are thus linked and operated jointly, and the rear two induction heating coils IR3 and IR4 likewise. Power setting may thus be performed jointly for both coils. By comparing the relative coverages with one another, the pan detection means may also determine that the front pan TR1 is placed more over the frontmost induction heating coil IR1 and the rear pan TR2 is placed more over the rear induction heating coil IR4.

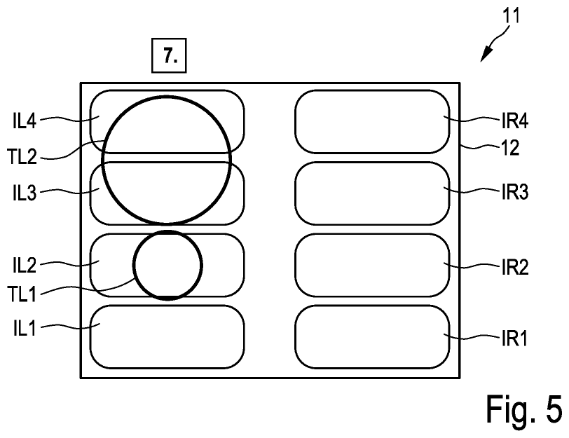

In FIG. 5, a small pan TL1 is placed on the left over the induction heating coil IL2, specifically such that it covers only this induction heating coil and neither of the two adjacent induction heating coils IL1 or IL3. Its diameter is even smaller than that of FIG. 3 and may be about 10 cm. The relative coverage of the induction heating coil IL2 is detected as roughly 40%. Furthermore, a somewhat larger pan TL2 with a diameter of around 18 cm has been placed over the rear two induction heating coils IL3 and IL4. The relative coverage of the induction heating coil IL3 is detected as around 65%, and for the rear induction heating coil IL4 a relative coverage of around 45% is detected. From this information, the above-stated 7th case is determined, i.e. that two cooking vessels TL1 and TL2 have been placed over the three induction heating means IL2 to IL4. At the same time, however, it is not possible to determine more precisely over which two induction heating coils a single pan has been jointly placed. The reason for this is that here the relative coverages of the outer induction heating coils IL2 and IL4 are identical in size and in turn smaller than the relative coverage of interposed induction heating coil IL3. The controller 17 thus here refrains from linking two induction heating coils IL and operating them together, since a corresponding analysis is impossible.

Furthermore, the controller 17 may determine that the relative coverage of the interposed induction heating coil IL3 is less than in the 3rd case on the left-hand side in FIG. 2. Consequently, it cannot be that a single large cooking vessel in the form of a casserole dish or the like is covering all three induction heating coils.

1. A method for operating a cooktop, wherein said cooktop comprises:
a cooktop plate,
at least three adjacent heating means being arranged along a straight line under said cooktop plate,
a pan detection means, wherein said pan detection means is configured to detect a relative coverage of each of said heating means by cooking vessels placed on said cooktop plate over said heating means,
wherein:
in a preceding step, said pan detection means is used to detect over which of said heating means one said cooking vessel has been placed and thus that said relative coverage of said heating means by said cooking vessel is present,
in a subsequent step, said pan detection means is used to detect how great is said relative coverage of each said heating means,
from a result of detecting said relative coverage of each said heating means and comparing said multitude of results for each said heating means with one another, a case analysis into one of several cases is carried out, wherein said cases relate to said coverage of said heating means with at least one said cooking vessel,
for a 1st case, in which it is detected for said three heating means arranged along said straight line, that said relative coverage of a middle heating means is less than said relative coverage of said other two adjacent heating means, it is determined that no said cooking vessel has been placed over said three heating means which contiguously covers all 3 heating means, but rather that at least two said cooking vessels have been placed over said three heating means.

2. The method of claim 1, wherein said pan detection means has at least three said pan detection sensors and said pan detection sensors are used to detect said cooking vessels placed over said heating means, and detect their placing location and said relative coverage of a respective heating means by said cooking vessels placed thereover.

3. The method of claim 1, wherein, in a step preceding said case analysis, said relative coverage of all said heating means by one or more said cooking vessels is detected using said pan detection means and said pan detection sensors.

4. The method of claim 1, wherein, for a 2nd case, which is based on said 1st case, and in which it is detected for said middle heating means between said two adjacent heating means that it has a relative coverage by at least one said cooking vessel placed thereover of greater than zero, and in which said relative coverage of said other two adjacent heating means is identical, it is determined that said three heating means are covered by precisely two said cooking vessels and one of said other two adjacent heating means is covered by precisely one first cooking vessel and said other two heating means are covered jointly by one second cooking vessel.

5. The method of claim 1, wherein, for a 3rd case, in which it is detected for said three heating means arranged along said straight line that said relative coverage of said middle heating means is greater than said relative coverage of said other two adjacent heating means, it is determined that a single cooking vessel has been placed over said three heating means which contiguously covers all said three heating means.

6. The method of claim 1, wherein, for a 4th case, in which a relative coverage of less than 20% is detected for said middle heating means, and relative coverages of more than 30% are detected for said other two adjacent heating means, it is determined that no said cooking vessel is placed over said middle heating means and in each case one said cooking vessel is placed over each of said other two adjacent heating means.

7. The method of claim 1, wherein, for a 5th case, in which it is detected for four adjacent said heating means arranged along said straight line that each thereof is covered by one said cooking vessel, said relative coverages of said middle two heating means are compared with said relative coverages of said outer two heating means, and if said relative coverages of said middle two heating means are in each case greater than in each case said relative coverages of said outer two heating means, it is then determined that a single, very large cooking vessel has been placed over all four said heating means, which contiguously covers all four said heating means, and if said relative coverages of said middle two heating means are in each case smaller than in each case said relative coverages of said outer two heating means, it is then determined that in each case one said cooking vessel has been placed over said outer two heating means and said adjacent middle heating means, jointly covering said two heating means.

8. The method of claim 1, wherein said relative coverages of said respective heating means are set in relation to one another, wherein a distinction is drawn between on the one hand heating means that are relatively extensively covered and on the other hand heating means that are relatively slightly covered.

9. The method of claim 8, wherein a distinction is drawn between on the one hand said relatively extensively covered heating means and said relatively slightly covered heating means either in that 50% of said most extensively covered heating means are classified into a group of extensively covered heating means and the other 50% into a group of slightly covered heating means, or in that heating means with a relative coverage of more than 50% are classified into said one group and heating means with a relative coverage of less than 50% into said other group of said heating means.

10. The method of claim 1, wherein no observation is made over time or it is irrelevant whether a cooking vessel is moved.

11. The method of claim 1, wherein said method is carried out only if said pan detection means or the pan detection sensors identify no movement of one said cooking vessel on said cooktop plate.

12. The method of claim 1, wherein, for a 6th case, in which, when a minimum relative coverage is detected between two said maximum relative coverages, it is determined that in each case precisely one said cooking vessel is placed over one said heating device with a maximum relative coverage, wherein an intermediate region between said two cooking vessels over said heating means with a minimum relative coverage is determined.

13. The method of claim 1, wherein, for a 7th case, in which one said heating device with a maximum relative coverage is detected between two said heating means with a minimum relative coverage, it is determined that two said cooking vessels are placed over said heating means, wherein one cooking vessel is placed over an interposed heating means and one of said adjacent heating means, and an other cooking vessel is placed over said other adjacent heating means, wherein said cooking vessel over said two heating means is larger than said other cooking vessel over said single heating means.

14. The method of claim 1, wherein said heating means are of rectangular configuration, with a length and a width, wherein said length is greater than said width, wherein said width is smaller than 20 cm, and greater than 8 cm, and wherein said length is greater than 15 cm and less than 30 cm.

15. The method of claim 1, wherein said three adjacent heating means are of identical configuration.

16. The method of claim 1, wherein it is determined that a total of at most two said cooking vessels are placed on three or four adjacent said heating means along a straight line.

17. The method of claim 1, wherein, in an event that no values are detected for relative coverage of said heating means arranged in said straight line which differ by more than 10%, or in an event that said relative coverage in each case amounts to less than 50%, it is assumed that two said cooking vessels have been placed over said heating means, wherein, in an event that said relative coverage amounts in each case to more than 50%, a very large cooking vessel over said heating means is assumed.

18. The method of claim 17, wherein said case analysis is performed for three or four said heating means arranged along said straight line.

19. A cooktop with:
a cooktop plate,
at least three heating means arranged adjacently along a straight line under said cooktop plate,
a pan detection means having at least three pan detection sensors, wherein said pan detection means with said pan detection sensors is configured to detect a number of cooking vessels placed on said cooktop plate over said heating means, their placing location and a relative coverage of said heating means by said cooking vessels placed thereover,
a cooktop controller,
wherein said cooktop controller is configured to carry out the method of claim 1.
